(19) United States
(12) Patent Application Publication
(10) Pub. No.: US 2009/0229360 A1
(43) Pub. Date: Sep. 17, 2009

(54) Bowl With Integrated Interior Measuring Gradations

(76) Inventor: Heather Harvey, Brooklyn, NY (US)

Correspondence Address: FOX ROTHSCHILD, LLP;Pittsburgh, 2000 Market Street, 10th Floor, Philadelphia, PA, 19103, US

(21) Appl. No.: 12/402,463

(22) Filed: Mar. 11, 2009

Related U.S. Application Data
(60) Provisional application No. 61/035,430, filed on Mar. 11, 2008.

(51) Int. Cl. G01F 19/00; B65D 25/56

(52) U.S. Cl. 73/427; 206/457; 206/459.1; 220/662

(57) ABSTRACT

A bowl having one or more grooves defined around the interior perimeter thereof, the grooves representing a specific measure of a material placed into the bowl when the bowl is filled to the level of one of the grooves. Each of the grooves have an indicia locate nearby that indicates the quantity associated with each groove.

### RELATED APPLICATIONS

This application claims the benefit of U.S. Provisional Patent Application Ser. No. 61/035,430, filed Mar. 11, 2008, and that application is incorporated herein in its entirety.

### BACKGROUND OF THE INVENTION

There is a disturbing trend of obesity among both adults and children in the United States. Estimates indicate that up to 80% of adults can be considered overweight, a percentage that has risen steadily since the early 1980's. Among children, approximately 16% can be considered overweight, a number that has tripled since 1980.

Overweight adolescents have a 70% chance of becoming overweight or obese adults. This increases to 80 percent if one or more parent is overweight or obese. Among those that are overweight, fully 33% are at least 20% over their ideal weights, which is considered “obese.” Experts say that obesity is an “epidemic” sweeping across the nation and destroying our quality of life. The real threat from obesity does not come from being overweight, but from the numerous health problems associated with being overweight. Obesity is associated with an increased risk for type 2 diabetes, hypertension, high cholesterol, heart disease, stroke, cancer, asthma, osteoarthritis, depression and sleep apnea.

There are many common misconceptions about the causes of obesity. Obesity does not develop from one single cause. Instead, many factors are involved in being overweight or obese. The actual fat deposits usually start from a poorly balanced diet, usually high in fats, oils, sugars, and starches, while at the same time lacking essential vitamins, minerals, and amino acids that help our bodies process the excess fats.

While individual body weight has a complex set of causes, most researchers attribute the recent increase in obesity among both adults and children to two simple facts: we have changed our lifestyle to one where we are eating more and exercising less. In the 1990s, Americans consumed more food and several hundred more calories per day than they did in the 1970s. This is attributed to fewer meals being eaten at home, average portion sizes growing, and the availability of convenience foods.

One factor contributing to the epidemic of obesity is a lack of portion control and a lack of awareness of the proper portion size. Information regarding the proper amounts of food that are considered normal and healthy portions is readily available. However, absent a convenient means for measuring the quantities of food, many people underestimate the actual amount of food being eaten, even when they are aware of the correct amounts. Therefore, even if healthy foods are being eaten, eating a larger than acceptable portions of these foods may nonetheless be detrimental to the success of one's diet.

As a result, there is a need to provide a convenient means to measure the quantity of food being eaten.

### SUMMARY OF THE INVENTION

The device of the present invention addresses the recognized need to provide dieters with an easy way to measure the quantity of food place into the bowl, and thereby control the portion size.

The invention consists of a bowl having quantity gradations marked on the interior thereof, which allows users to measure out a certain amount of food and eat it within the same container. Preferably, the marking consists of one or more grooves around the interior perimeter of the bowl which may be colored and which may have an indicia marked nearby showing a quantity. When a quantity of an item is placed into the bowl, filling the bowl to one of the grooved gradations provides a visual display of the measure of the quantity in the bowl.

As a result of using the bowl, dieters are able to know with certainty the quantity of food placed into the bowl, and will thereby learn how much food typically comprises an acceptable portion. Likewise, children using the bowl learn at an early age the proper quantity of food in an acceptable portion, and will hopefully gain healthy eating habits as the result of the use of the bowl. The bowl will thus assist dieters in controlling their calorie intake and will help to promote a healthier lifestyle.

### DESCRIPTION OF THE DRAWINGS

FIGS. 1-3 show cross-sectional and isometric views of bowls of various sizes and configurations according to the invention.

### DETAILED DESCRIPTION OF THE INVENTION

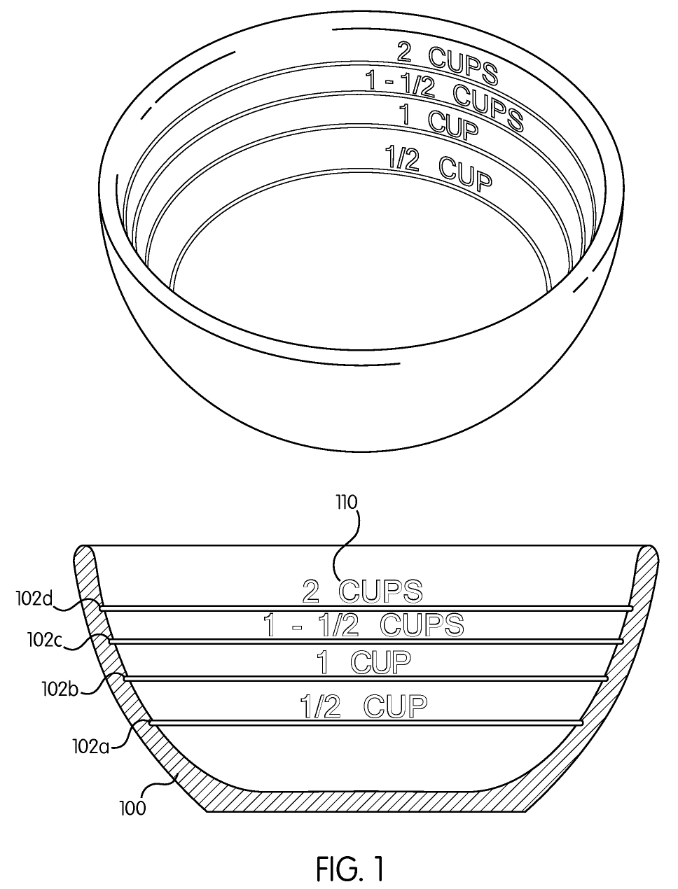

The preferred embodiment of the invention is shown in various configurations in FIGS. 1-3. FIG. 1 shows the classic bowl which would consist of body 100 having grooves 102a-d circumscribed around the interior perimeter thereof. Each one of the groves represents a height within the bowl which, when the bowl is filled with a material to that particular height will result in a specific quantity of the material being contained in the bowl. Thus, each groove represents the cross section of the top surface of a volume defined by the interior of the bowl below that surface. Preferably, the volumes defined by each of the grooves represents convenient measures that would be used in the measurement of food, such as cups or ounces. Although FIG. 1 shows four grooves, bowls having any number of grooves defined therein are within the scope of the invention.

The grooves thus represent a convenient way to measure foods or other materials placed into the bowl, and are especially convenient for the measurement of liquids, since liquid contents often form a meniscus on the upper surface thereof which may make it difficult to determine the height of the liquid within the bowl.

Preferably interior grooves 102a-d will be painted or otherwise colored. The grooves may be any color, but preferably, will be of a color that contrasts with the color of the of the interior surface of the bowl. The coloring within the groove may be applied via painting, glazing or via a decals or. Alternatively, the grooves may be left uncolored.

Also defined within bowl are indicia 100 indicating the quantity of material which would be contained in the bowl if the bowl is filled to the height of a particular groove. Thus, each groove will preferably have an indicia in close proximity to it. In the embodiment shown in FIGS. 1-3, the indicia is shown in half or quarter cup increments but the increments may be any convenient measurement including, for example, metric measurements.

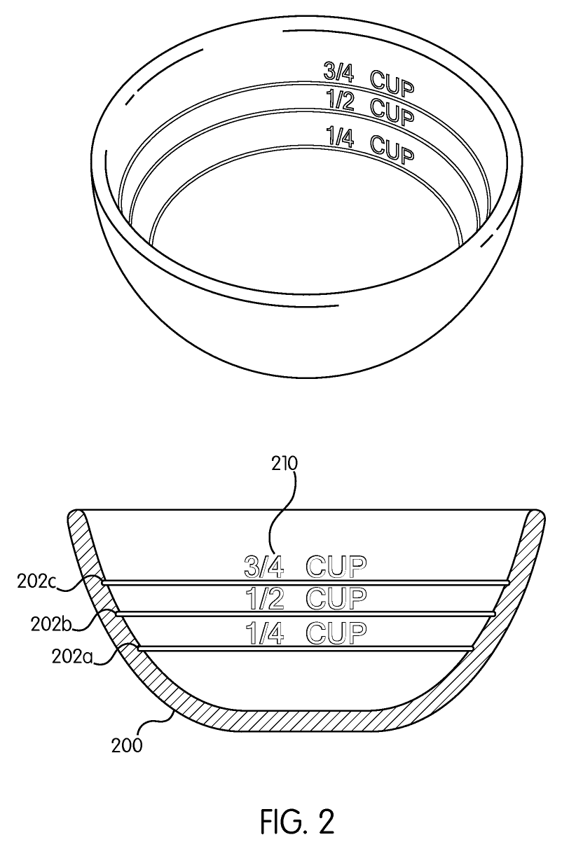

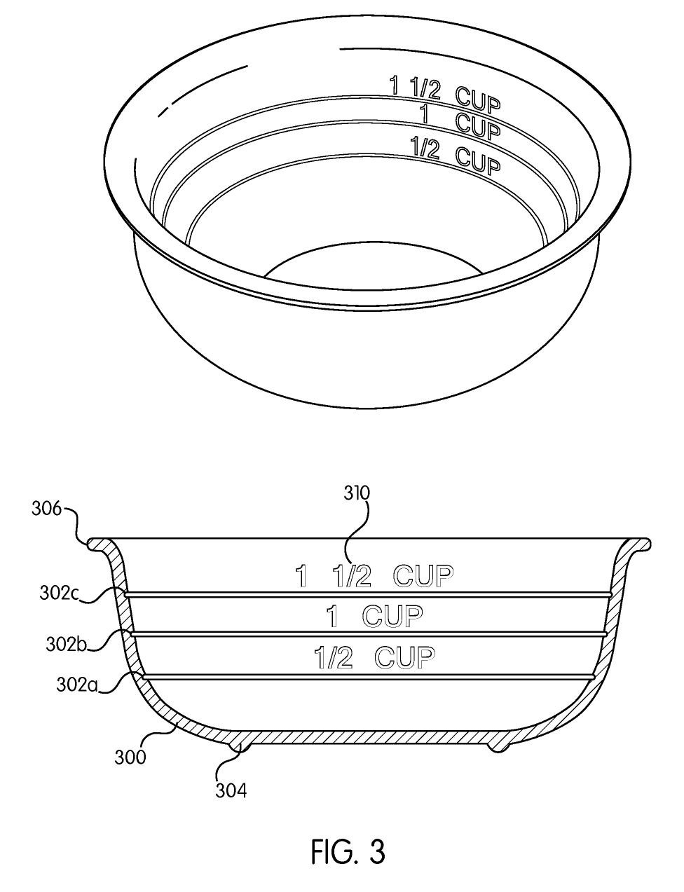

In the preferred embodiment the classic bowl shown in FIG. 1 is approximately six inches wide and three inches high, however the invention is not meant to be limited to a particular dimensions and bowls of any dimensions are to be considered within the scope of the invention, as can be seen in FIG. 2, showing a small bowl having dimensions approximately 5″ in diameter and 2.25″ high and in FIG. 3 showing a children's bowl having a diameter of 6″ and a height of approximately 2.25″.

The bowl can be constructed of any convenient material including, for example, metal, plastic, porcelain, ceramic, glass, china, wood, a composite material or any other material well known in the art for the construction of bowls or plates. Preferable, the bowl is microwave and dishwasher compatible. The bowls may be opaque or translucent and the interior of the bowl may be colored or otherwise decorated via painting, glazing or via a decal. In the case of a children's bowl, for example, a comical figure may be applied to the bottom surface of the bowl.

Indicia 110 may be applied via paint, glazing or via decal or may consist of raised letters defined on the interior of the bowl, which may be colored or left the same color as the interior surface of the bowl.

An alternative embodiment of the bowl, shown in FIG. 3, may include a lip 306 defined at the top of the bowl and may include feet 304 defined on the bottom of the bowl which consist or be coated with a non-skid material to keep the sliding or slipping on a flat surface.

Bowls may be defined in sets containing a plurality of bowls of the same or varying sizes.

I claim:

1. A bowl comprising:
a. a bowl-shaped body;
b. said body having one or more circular grooves inscribed around the interior perimeter thereof at differing heights, each of said grooves representing the top surface of a volume of a specific size defined by the interior surface of said bowl below said groove.

2. The bowl of claim 1 further comprising indicia, placed in close proximity to each of said one or more grooves, said indicia indicating the size of said volume corresponding to each of said grooves.

3. The bowl of claim 2 wherein said one or more grooves are colored.

4. The bowl of claim 3 wherein said color of said grooves is contrasts with the color of the interior surface of said bowl.

5. The bowl of claim 3 wherein said colors are applied to each of said one or more grooves via painting, glazing or decal.

6. The bowl of claim 2 wherein said indicia indicate said volumes in U.S. or metric measures.

7. The bowl of claim 2 wherein said indicia are formed from raised letters defined on the interior surface of said bowl

8. The bowl of claim 2 wherein said indicia are applied via painting, glazing or decal.

9. The bowl of claim 1 wherein said body is composed of a material selected from a group consisting of metal, plastic, ceramic, porcelain, china, glass, wood and a composite material.

10. The bowl of claim 1 wherein said body is translucent or opaque.

11. The bowl of claim 1 wherein said interior surface of said bowl is decorated and further wherein said decoration may be applied via painting, glazing or decal.

12. The bowl of claim 1 wherein said body defines a curled lip on the upper surface thereof.

13. The bowl of claim 1 wherein said body defined legs on the lower exterior surface thereof.

14. The bowl of claim 1 wherein said legs may be composed of or coated with a non-skid material.

15. A bowl comprising:
a. a bowl-shaped body;
b. said body having one or more circular grooves inscribed around the interior perimeter thereof at differing heights, each of said grooves representing a specific quantity of material placed into said bowl when said bowl is filled to the level of one of said grooves with said material.

16. The bowl of claim 15 further comprising indicia, placed in close proximity to each of said one or more grooves, said indicia indicating said specific quantity of material corresponding to each of said grooves.

17. A set of two or more bowls, each of said bowls comprising:
a. a bowl-shaped body;
b. said body having one or more circular grooves inscribed around the interior perimeter thereof at differing heights, each of said grooves representing the top surface of a volume of a specific size contained within said bowl.

18. The set of bowls of claim 17 wherein each of said bowls in said set of bowls is a different size.

19. The set of bowls of claim 17 wherein each of said bowls in said set of bowls is the same size.

20. The set of bowl of claim 17 further comprising indicia, placed in close proximity to each of said one or more grooves, said indicia indicating the size of said volume corresponding to each of said grooves.
